(19) United States
(12) Patent Application Publication
(10) Pub. No.: US 2013/0163489 A1
(43) Pub. Date: Jun. 27, 2013

(54) Method and System Providing Interoperability Between Wireless Gigabit Alliance I/O PAL and A/V PAL Devices

(71) Applicants: Keith Shu Key Lee, Markham (CA); Syed Hussain, Scarborough (CA); Lei Zhang, Richmond Hill (CA); Gordon F. Caruk, Brampton (CA); David I.J. Glen, Toronto (CA)

(72) Inventors: Keith Shu Key Lee, Markham (CA); Syed Hussain, Scarborough (CA); Lei Zhang, Richmond Hill (CA); Gordon F. Caruk, Brampton (CA); David I.J. Glen, Toronto (CA)

(21) Appl. No.: 13/336,455

(22) Filed: Dec. 23, 2011

(51) Int. Cl. H04W 4/00; H04J 3/22

(52) U.S. Cl. 370/310

(57) ABSTRACT

A method and system are provided for transmitting wireless signals from a source station having a WGA IO PAL device to one or more destination stations having WGA AV PAL device according to a protocol adaptation layer translation mechanism whereby received data and control packets formatted in accordance with a first protocol adaptation layer or translated into translated data and control packets formatted in accordance with a second different protocol adaptation layer prior to conveyance in accordance with the second different protocol adaptation layer.

### BACKGROUND OF THE INVENTION

1. Field of the Invention

The present invention relates in general to the field of wireless communications technology. In one aspect, the present invention relates to a method and system for providing interoperability among different device protocols communicating according to a standard, such as the Wireless Gigabit Alliance standard.

2. Description of the Related Art

The Wireless Gigabit Alliance (WGA or WiGig) is developing and promoting a multi-gigabit speed wireless communications standard for high performance wireless data, display and audio applications by defining Physical (PHY) and Medium Access Control (MAC) layers based on IEEE 802.11. The WiGig standard makes it simpler and less expensive to produce devices that can communicate wirelessly, To support high speed (e.g., over 60 GHz) peripheral data and display devices, the WiGig standard includes Protocol Adaptation Layers (PALs) which allow wireless implementations of the standard data and display interfaces that run directly on the WiGig MAC and PHY. The originally defined PALs included an audio-visual (AV) PAL (which defines support for HDMI and DisplayPort standards) and an input-output (IO) PAL (which defines support for USB and PCIe standards). The AV PAL has been renamed the WiGig Display Extension (WDE), and the IO PAL has been renamed so that the USB PAL is now WiGig Serial Extension (WSE), and the PCIe PAL is now WiGig Bus Extension (WBE), In addition, efforts are underway to develop an SD PAL for SDIO standard for linking to SD cards. Even though the MAC and PHY layers are interoperable, the WiGig standard does not currently enable interoperability between IO and AV PAL devices, so WGA IO PAL devices cannot send data to WGA AV PAL only devices without running into interoperability issues. As a result, WGA devices can be designed as IO PAL devices only or as AV PAL devices only, or as a combination of IO PAL and AV devices.

Accordingly, a need exists for improved wireless communication devices method, and systems which address various problems in the art that have been discovered by the above-named inventors where various limitations and disadvantages of conventional solutions and technologies will become apparent to one of skill in the art after reviewing the remainder of the present application with reference to the drawings and detailed description which follow, though it should be understood that this description of the related art section is not intended to serve as an admission that the described subject matter is prior art.

### SUMMARY OF EMBODIMENTS OF THE INVENTION

Broadly speaking, the present invention enables interoperability between different types of wireless protocol adaption layer devices (e.g., IO and AV PAL devices) by adding a protocol translation layer to a first wireless device which is designed for only a first protocol adaption layer (e.g., WGA IO source device). Using the protocol translation layer to translate between different packet types, the first wireless device communicates with a second wireless device which is designed for only a second protocol adaption layer (e.g., a WGA AV sink device). In these embodiments, the protocol translation layer may be implemented as an IO2AV translation layer which translates selected outgoing IO PAL packets into AV packets before sending it to the MAC and PHY. For incoming packets, the protocol translation layer may include an AV2IO translation layer which translates selected incoming AV PAL packets into IO PAL packets before sending the packets to the upstream device. Together or singly, the AV2IO and IO2AV translation layers may be referred to as IO/AV translation layer. In embodiments where the first wireless device is a notebook computer which includes only a WGA IO PAL device, the notebook computer uses an IO/AV protocol translation layer to send data. to WGA AV sink devices for wireless display type of applications, thereby promoting interoperability between the WGA IO and AV devices. The first wireless device is otherwise capable of using the WGA IO PAL device for high speed data transfer to WGA IO sink devices, such USB and/or PCIe interfaced devices. By eliminating the requirement of combining two different PAL devices at the source (or sink), improved interoperability is achieved with lower fabrication costs and reduced power consumption. When implemented with a protocol translation layer at a source device, such as a notebook which has only a WGA IO device, no changes are required at the AV PAL sink device(s).

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates alike or similar element.

FIG. 1 illustrates a simplified architectural block diagram of a wireless network in which a conventional source device and plurality of sink devices are capable of wirelessly communicating with each other.

FIG. 2 illustrates a simplified architectural block diagram of a WGA IO PAL source device which uses a PAL translator to wirelessly communicate with WGA AV and IO sink devices in accordance with selected embodiments of the present invention,

FIG. 3 illustrates a high level block diagram of a WGA AV PAL source device which uses a WGA IO device with an IO/AV PAL translation layer to wirelessly send display and/or audio data to a WGA AV sink device for display.

FIG. 4 illustrates a high level block diagram of a WGA AV PAL source device which uses a WGA IO PAL device to wirelessly send display and/or audio data as IO PAL packets to a WGA AV sink device having an IO/AV PAL translation layer.

FIG. 5 illustrates a high level block diagram of using a plurality of WGA IO PAL devices to wirelessly send display data as IO PAL packets to a WGA AV sink device having an IO/AV PAL translation layer.

FIG. 6 depicts an exemplary flow methodology for translating incoming data packets to IO and AV PAL packets.

### DETAILED DESCRIPTION

A method and apparatus are provided for enabling a wireless device which integrates only a first type of wireless PAL device to communicate with different types of wireless PAL devices by using a PAL translation layer at either the transmitter or receiver. In selected embodiments, a wireless device which integrates only a WGA IO PAL device includes an IO/AV translation layer at the WGA IO PAL device to enable communication with WGA IO PAL sink devices (using the WGA IO device) and with WGA AV PAL sink devices (using the IO/AV translation layer). With these example embodiments, AV PAL packets are extracted from incoming data packets and presented directly to the MAC layer without processing by the IO PAL, thereby enabling audio/video data to be transmitted from a wireless WGA IO PAL device to a wireless AV PAL device without requiring that a separate wireless WGA AV PAL device be included at the transmitter. In other embodiments, a wireless WGA AV PAL sink device includes an IO/AV translation layer so that a wireless device which integrates only a WGA IO PAL device can communicate with the WGA IO PAL sink device by translating IO packets into AV packets using the IO/AV translation layer at the WGA AV PAL sink device. IO PAL packets received at the sink device include payload for conveying AV PAL packets which are extracted or translated by the IO/AV layer back into AV PAL packets. In yet other embodiments, a wireless device which integrates only a WGA IO PAL device wirelessly transmits IO packets over a plurality of WGA IO PAL devices to a WGA AV PAL sink device which includes an IO/AV translation layer. In these embodiments, AV PAL packets may be embedded in wirelessly transmitted IO packets, IP packets, or any desired transmission format.

Various illustrative embodiments of the present invention will now be described in detail with reference to the accompanying figures. While various details are set forth in the following description, it will be appreciated that the present invention may be practiced without these specific details, and that numerous implementation-specific decisions may be made to the invention described herein to achieve the device designer's specific goals, such as compliance with process technology or design-related constraints, which will vary from one implementation to another. While such a development effort might be complex and time-consuming, it would nevertheless be a routine undertaking for those of ordinary skill in the art having the benefit of this disclosure. For example, selected aspects are shown in block diagram form, rather than in detail, in order to avoid limiting or obscuring the present invention. Some portions of the detailed descriptions provided herein are presented in terms of algorithms and instructions that operate on data that is stored in a computer memory. Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities. Unless specifically stated otherwise as apparent from the following discussion, it is appreciated that, throughout the description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

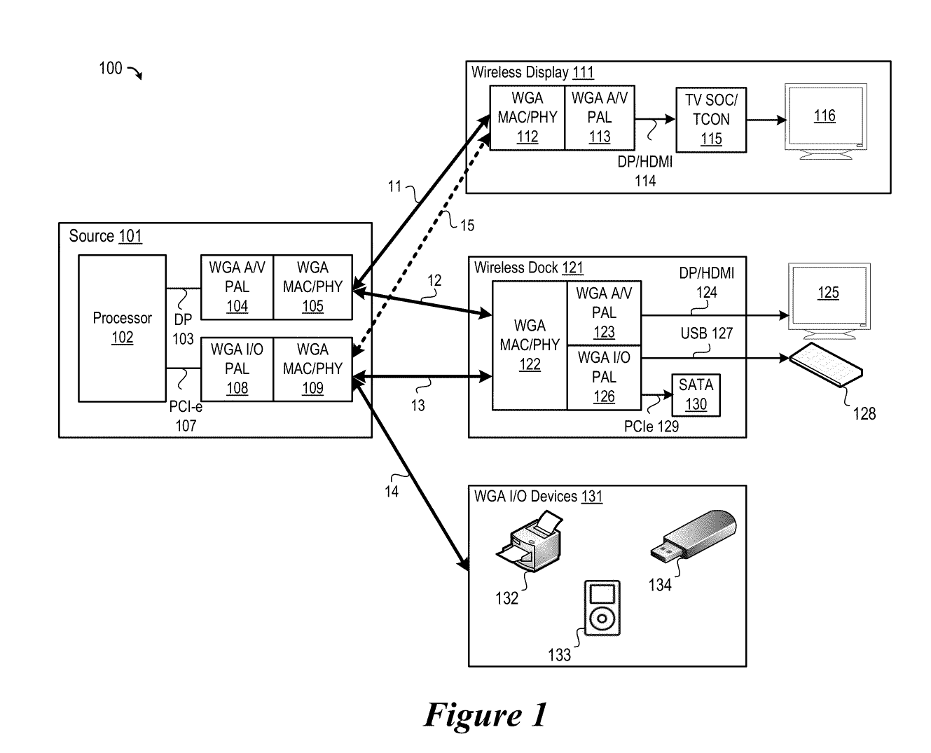

To provide a contextual understanding for selected embodiments of the present invention, reference is now made to FIG. 1 which illustrates a simplified architectural block diagram of a wireless network 100 in which a conventional source device or station 101 and plurality of destination or sink devices 111, 121, 131-134 are capable of wirelessly communicating with each other. The wireless network 100 may be any type of wireless network, such as a wireless local area network (WLAN) or a wireless personal area network (WPAN) operating according to Wireless Gigabit Alliance (WGA or WiGig) or other wireless standard. The source 100 and destinations 111, 121, 131-134 are often referred to as wireless stations. In the wireless network 100, the source station 101 may be a mobile device, set top box, notebook computer, laptop or personal computer (PC), a DVD player, a CD player, an MP3 player, a digital video recorder (DVR), a still or video camera, a game console, a cellphone or smartphone, a personal digital assistant (PDA), and other devices. In addition, the destination stations may include a television monitor or display 111, a wireless dock 121, a wireless data device 131 (such as a printer 132, media. player 133, or USB flash drive 134), receiver, speakers, laptop or personal computers, cellphones or smartphones, personal digital assistants (PDAs), projectors, and other devices. Using the wireless network 100, the source station 101 wirelessly communicates with destination stations 111, 121, 131-134, such as by transmitting data and transmission messages 11-15 or receiving data and transmission messages (not shown).

In order to send audio/video (AV) data and exchange AV control data over wireless WiGig connections 11, 12 with wireless display stations 111, 121, the source station 101 includes a processor 102 which generates and outputs AV data 103 over a display port (DP) or any desired display interface. Under the WiGig wireless protocol which implements OSI (Open System interconnection) Reference Model (seven-layer model), the AV data. is then processed by the WGA AV PAL layer 104. The AV PAL 104 generates encoded AV packets, which in turn are processed by the WGA MAC/PHY layer 105 for broadcast transmission 11, 12 to the destination stations 111 which support wireless WGA display applications. in operation, the wireless display station 111 processes the received transmission message 11 with the WGA MAC/PHY layer 112 to generate decoded AV packets, which in turn are processed by the dedicated WGA AV PAL entity or device 113 to generate decoded AV data 114 over the HDMI or DisplayPort interface. The decoded AV data is then processed further for display on a screen 116, such as by applying the decoded AV data to a TV controller system-on-chip (SOC) and/or TV panel Timing Controller (TCON) 115 to generate AV data for display at the monitor device 116.

The source station 101 may also be adapted to exchange input/output (IO) data over wireless WiGig connections 13, 14 with wireless destination stations 131, 121. However, this capability has conventionally required that the source station 101 include a separate or additional WGA IO PAL device 106 which receives IO data 107 over a data interface (e.g., PCI-e) from the processor 102, and generates encoded IO packets, which in turn are processed by the WGA MAC/PHY layer 109 for broadcast as IO data transmissions 13-15 to the destination stations. And in order for the destination stations 121, 131-134 to receive the IO data transmission messages, the received IO data transmission message 13, 14 is processed with a WGA MAC/PHY layer (e.g., 122) to generate decoded IO packets, which in turn are processed by a dedicated WGA IO PAL device (e.g., 126) to generate decoded IO data 127, 129. The decoded IO data is then provided to a peripheral data device, such as a keyboard 128, Serial Advanced Technology Attachment (SATA) 130, or other wireless data devices 131, including but not limited to a printer 132, media player 133, or USB flash drive 134.

Currently, WiGig specifications do not enable interoperability between IO and AV PAL devices, even though the MAC and PHY layers are interoperable. In FIG. 1, this is shown by the failed IO data transmission message 15 (shown with a dashed line) sent by the WGA IO PAL device (e.g., 106) to the wireless display 111 which has only a WGA AV PAL device 113. As seen from the foregoing, a conventional source device or station 101 must include both a dedicated AV PAL device 104 and a dedicated IO PAL device 108, along with separate MAC/PHY layer 105, 109 or a single shared MAC/PHY layer) in order to support wireless transmissions to both display and data destination stations 111, 121, 131. In similar fashion, a conventional destination station 121 must include both a dedicated AV PAL device 123 and a dedicated IO PAL device 126 (along with separate or shared MAC/PHY layer 122) in order to support wireless AV and IO transmission messages 12, 13 for display and data applications. As a result of requiring separate and dedicated AV and IO PAL devices to support both display and data applications at a single station, the resulting assembly and design costs, power consumption, and complexity for the station is increased.

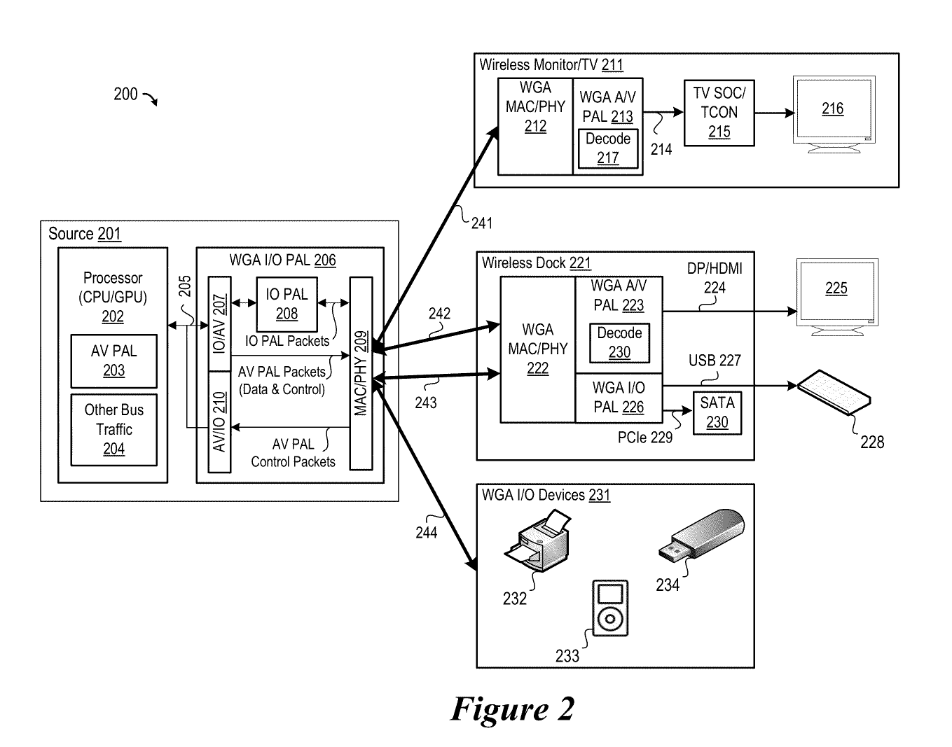

In order to address the limitations and drawbacks associated with conventional WGA stations, there is disclosed herein a translation mechanism to cross the AV PAL and IO PAL layers at a station, thereby eliminating the requirement for separate dedicated AV and IO PAL devices at each station. To provide selected examples of such a translation mechanism, reference is now made to FIG. 2 which illustrates a simplified architectural block diagram of a wireless network 200 in which a source device 201 uses one or more PAL translation layers 207, 210 to wirelessly communicate with both WGA AV and IO sink devices 211, 221, 231. As illustrated, the source device 201 may be implemented as a mobile device, desktop PC, media player, or any other station which integrates only a WGA IO PAL device 206 without having a separate dedicated AV PAL device. In support of sending IO data over wireless WiGig connections 243, 244, IO data 205 generated by processor 202 (e.g., as PCIe data) is processed by the WGA IO PAL device 206 to generate encoded IO packets which are processed by the WGA MAC/PHY layer 209 for transmission over a transceiver circuit (not shown). To this end, IO data packets from the incoming data signal 205 are processed by the IO/AV translation layer 207 and presented to the IO PAL 208 where they are assembled into IO PAL packets and presented to the MAC/PHY layer 209. At the intended destination station (e.g., wireless dock 221), IO data transmission messages 243 generated by the WGA IO PAL device 206 are received and processed with a WGA MAC/PHY layer 222 to generate decoded IO packets. These decoded IO packets are then processed by a WGA IO PAL device 226 to generate decoded IO data 227, 229 that may be provided to peripheral data device(s) 228, 230.

The source device 201 is also configured to send AV data by using the IO/AV translation layer 207 to extract AV PAL packets from the incoming data 205 for direct processing by the MAC/PHY layer 209 without processing by the IO PAL 208. In an example embodiment where the processor 202 includes an AV PAL unit 203 and circuitry or modules 204 for generating other bus traffic, the AV PAL unit 203 may divide each AV packet into n AV PAL blocks (e.g., AV PAL B1, AV PAL B2, . . . AV PAL Bn) for insertion into the IO data signal 205 (e.g., as PCIe payloads). Upon receipt at the WGA IO PAL device 206, the IO/AV translation layer 207 may identify and extract the AV PAL blocks for assembly into AV PAL packets before sending them directly to the WGA MAC/PHY layer 209. At the intended destination station (e.g., wireless monitor/TV 211), the received AV data transmission message 241 is processed with the WGA MAC/PHY layer 212 to generate decoded AV packets. The WGA AV PAL device 213 may then use a decoder 217 to process the decoded AV packets to generate decoded AV data 214 that may be provided to TV SOC/TCON 215 for display at AV device 216. In order to receive and process AV PAL control packets, the WGA IO PAL device 206 may also include an AV/IO translation layer 210 (either separately or as a single IO/AV translation layer) which translates the appropriate incoming AV PAL control packets into the appropriate interface for the data 205 packets before sending the translated packets to the upstream device (e.g., CPU/GPU processor 202). As will be appreciated, incoming AV PAL packets may include AV control data.

With the IO/AV translation layer(s) 207, 210 at the IO PAL device 206, the source station 201 is interoperable between IO PAL and AV PAL devices, and there are no changes required in the destination station's AV PAL device. In other words, the source station 201 can use its WGA IO PAL device 206 and IO/AV translation layer 207 to send AV data transmission messages 241 to peripheral AV devices 211. In addition or in the alternative, the source station 201 can use its WGA IO PAL device 206 to send IO data transmission messages 244 to peripheral data devices 231. Finally, the source station 201 can use the WGA IO PAL device 206 and IO/AV translation layer 207 to send both IO and AV data. transmission messages 242, 243 to peripheral devices, such as wireless dock 221, which include both types of PAL devices. In the case of a source station 201 which is implemented as a notebook computer or other handheld mobile device, there significant cost, power, and performance benefits of integrating only a WGA IO device and still being able to work with WGA AV sink devices for wireless display type of applications.

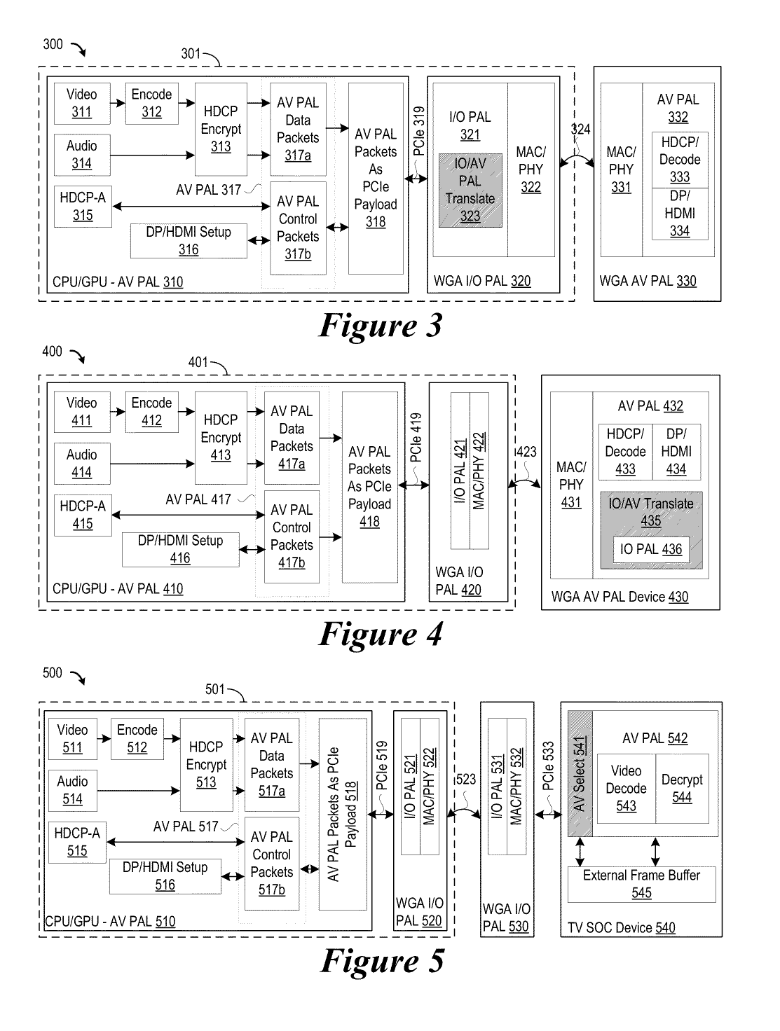

For an illustration of an example system implementation, reference is now made to FIG. 3 which illustrates a high level block diagram of a wireless communication network 300 in which a computer source station 301 uses a WGA IO PAL device 320 with an IO/AV PAL translation layer 323 to wirelessly send display and/or audio data to a WGA AV PAL sink device 330 for wireless display applications.

In the computer source station 301, there is provided a CPU/GPU sub-system 310 which handles a number of functions relating to the generation of IO and AV data. Though not explicitly shown, it will be appreciated that the CPU/GPU sub-system 310 may include one or more processors or processor cores connected to a memory and integrated graphics processing unit (GPU) over one or more bridge or bus circuits, such as a PCI Express (PCI-E) bus, an Alink bus, a serial AT Attachment (SATA) interface, a USB interface, etc. Of course, other buses, devices, and/or subsystems may be included in the computer system 301 as desired, e.g. caches, moderns, parallel or serial interfaces, SCSI interfaces, etc. In an example implementation, the CPU/GPU sub-system 310 includes an audio unit 314 and video unit 311 which respectively generate audio and video (or display) data for subsequent processing to form AV data. At the encoding unit 312, the video data is encoded or compressed to reduce the data rate and/or for rate adaption due to channel degradation, though the data compression step could be skipped if sufficient bandwidth is available on the wireless link. In addition, a high-bandwidth digital content protection (HDCP) unit 313 processes the audio and video data to provide downstream device authentication and data encryption if copy protection if required. In selected embodiments, the encoded display data and uncompressed audio data are encrypted using the HDCP2.0 encryption standard.

At the AV PAL unit 317, AV PAL virtualization is performed with the data packet module 317a and control packet module 317b. At the data packet module 317a, outgoing encoded display and audio data are encapsulated into video and audio AV PAL data packets, where each AV packet includes an AV PAL header and payload portions. In addition, the control packet module 317b generates AV PAL control and bypass packets for display link setup and maintenance. The AV PAL unit 317 may also provide a setup function to provide device authentication if copy protection is required. For incoming AV data, the control packet module 317b extracts AV control and AV bypass packets received from remote AV sink through PCIe payload. in addition, the data packet module 317a interprets AV PAL control and bypass packets for display link setup and maintenance and device authentication if necessary. The AV PAL unit 317 may send and receive the AV PAL control and data packets to and from the format unit 318 which formats AV PAL packets for delivery to or from an IO data interface 319, such as a PCIe interface, though other physical interfaces (e.g., USB and Ethernet) could be used provided that they provide enough through put for the appropriate applications. For example, with a USB interface, AV packets could be embedded in the USB payloads instead of PCIe payloads. For example, the format unit 318 may divide each outgoing AV packet into n AV PAL blocks (e.g., AV PAL B1, AV PAL B2, . . . AV PAL Bn), and then insert each AV PAL block into the data signal 319 as a PCIe payload (e.g., TLP data) with a PCIe header (e.g., TLP header). Of course, there may be other non-AV PAL data inserted in different PCIe payload portions

The WGA IO PAL device 320 processes the AV PAL control and data. packets using defined high-performance wireless implementations of widely used computer IO interfaces, such as USB and PCIe standards. In operation, the IO PAL 321 at the WGA IO PAL device 320 receives source data as control and data packets from the CPU/GPU sub-system 310, prepares the packets to be transmitted, and sends the packets to the MAC/PHY layer 322 for processing and transmission 324, depending on the intended data application. The processing of outgoing IO data by the WGA IO PAL 321 is performed in accordance with the well-defined requirements of the WiGig standard, and will not be described in further detail here. However, in order to process outgoing AV PAL packets, the WGA IO PAL device 320 includes an IO/AV PAL translation layer 323 which is configured to recognize or locate AV PAL packets in the incoming the PCIe payload 319, such as by using PCIe address offsets. In addition, the IO/AV PAL translation layer 323 performs additional IO to AV translation functions by extracting AV PAL packets from the PCIe payload, and presenting the extracted AV PAL packets directly to the MAC layer in the MAC/PHY unit 322 without further processing by the IO PAL. In the reverse direction, the IO/AV PAL translation layer 323 performs AV to IO translation functions by identifying AV PAL packets received from remote WGA AV sink. At the IO/AV PAL translation layer 323, each received AV PAL packet is divided into m AV PAL blocks (e.g., AV PAL B1, AV PAL B2, . . . AV PAL Bm), and each AV PAL block is inserted into the data signal 319 as a PCIe payload (e.g., TLP data) with a PCIe header (e.g., TLP header) and sent as PCIe payload to the appropriate PCIe addresses based on packet type. At the AV PAL 317, the AV PAL blocks from the PCEe signal 319 are assembled and processed as an AV PAL packet.

By using the IO/AV PAL translation layer 323 to translate the outgoing data into AV packets for MAC/PHY processing and transmission, the source station 301 is able to transmit AV packets 324 to a receiving/sink station with an AV PAL device 330 without requiring a dedicated WGA AV PAL device. At the receiving/sink station, the received message 324 is processed by the MAC/PHY layer 331 to generate AV packets that are processed by the AV PAL device 332 in accordance with the well-defined requirements of the WiGig standard. The AV PAL device 332 may also provide HDCP and/or decoding at the HDCP/decode unit 333 along with an interface unit 334 for data port (DP) and/or high-definition multimedia interface (HDMI). After PAL processing, the AV data is then sent to an upper functional layer (not illustrated).

As described herein above, the inclusion of an IO/AV translation layer in the WGA IO PAL device of the source station eliminates the need for a dedicated WGA AV PAL device at the source station. However, in accordance with other embodiments, the IO/AV translation layer may instead be added to the WGA AV sink device. For an example illustration of these embodiments, reference is now made to FIG. 4 which illustrates a high level block diagram of a wireless communication network 400 in which a computer source station 401 wirelessly sends display and/or audio data as IO PAL packets to a WGA AV PAL sink device 430 for wireless display applications, where the WGA AV PAL sink device 430 includes an IO/AV PAL translation layer 435. The operation of the computer source station 401 is quite similar to the source station 301 shown in FIG. 3, except there is no IO/AV PAL translation layer. In particular, the CPU/GPU sub-system 410 generates IO and AY data using the audio unit 414 and video unit 411 and (optional) encoding unit 412 and HDCP unit 413. The (encrypted) audio and video data are packetized or virtualized at the AV PAL unit 417 by using the data packet module 417a to encapsulate the outgoing encoded display and audio data into video and audio AV PAL data packets, and using the control packet module 417b to generate AV PAL control and bypass packets for display link setup and maintenance. The AV PAL control and data packets are sent to/from the WGA IO PAL device 420 as PCIe payloads 419 (or some other appropriate interface) where they are processed at the IO PAL layer 421 in accordance with the well-defined IO PAL requirements of the WiGig standard, and then sent to the MAC/PHY layer 422 for processing and transmission 423. At the receiving/sink station, the received message 423 is processed by the MAC/PHY layer 431 and IO/AV translation layer 435 to generate AV packets that are processed by the AV PAL device 432 in accordance with the well-defined requirements of the WiGig standard. The AV PAL device 432 may also provide HDCP and/or decoding at the HDCP/decode unit 433 along with an interface unit 434 for data port (DP) and/or high-definition multimedia interface(HDMI). After PAL processing, the AV data is then sent to an upper functional layer (not illustrated).

In operation, the WGA IO PAL device 420 operates as a standard IO PAL device and includes no special processing for AV PAL packets, other than to convey the PCIe bus transactions in the IO PAL payload (which encapsulates the AV PAL packets) in the IO PAL payload of the transmitted message 423. Instead of providing a translation function at the source station 401, the WGA AV PAL device 430 at the receiver/sink station includes an IO/AV PAL translation layer 435 with an IO PAL 436 which are configured to perform IO to AV translation functions by identifying IO and AV PAL packets in the received message 423 from remote WGA IO PAL 420, and then sending AV PAL packets upstream (e.g., as PCIe payloads to the appropriate PCIe addresses based on packet type). In effect, the IO/AV PAL translation layer 435 translates received PCIe packets back into AV PAL packets. In the reverse direction, the IO/AV PAL translation layer 435 is configured to translate outgoing AV PAL packets into IO PAL packets (e.g., an AV/IO translation function) which are presented to the MAC layer in the MAC/PHY unit 431 for transmission. The IO PAL packets are sent to pre-defined addresses so that the AV PAL packet processor 418 can extract the incoming AV PAL packets and send them to an upper layer at the source station 401 for processing. By using the IO/AV PAL translation layer 435 to translate the received data into AV packets, the receiver/sink station is able to receive IO packets 423 from the source station 401 with a WGA AV PAL device 430 without requiring a dedicated WGA IO PAL device. Thus, there is no change required on the WGA IO PAL device 420 of the source station since the WGA AV sink device is enhanced to include an IO/AV PAL translation layer 435. However, it will be appreciated that interoperability is only guaranteed if all WGA AV sink devices implement the IO/AV PAL translation layer. And apart from adding the IO/AV translation layer 435 to the AV PAL sink devices, there is no additional logic required for the IO PAL source or sink devices, nor are any changes required for the IO PAL and AV PAL specifications. In these embodiments, AV PAL sink devices can receive AV data directly from AV PAL source devices, or indirectly from IO PAL source devices.

In accordance with other embodiments disclosed herein, the inclusion of IO/AV translation layers between different PAL layers may also be extended to include two or more WGA IO PAL devices. For an example illustration of these embodiments, reference is now made to FIG. 5 which illustrates a high level block diagram of a wireless communication network 500 in which a computer source station 501 wirelessly sends display and/or audio data as IO PAL packets across a plurality of WGA IO devices 520, 530 for wireless display applications by including an AV selection unit 541 at the sink system upstream from the WGA IO PAL devices (e.g., in the TV SOC or TCON device). In this arrangement, source station 501 and WGA IO PAL devices 520, 530 do not include any IO/AV PAL translation layer functionality as described hereinabove, but instead operate conventionally At the source station 501, the CPU/GPU sub-system 510 generates IO and AV data using the audio unit 514, video unit 511, encoding unit 512, and HDCP unit 513. At the AV PAL unit 517, encrypted audio and video data are virtualized using the data packet module 517a and control packet module 517b, and the AV PAL control and data packets are sent to the WGA IO PAL device 520 as PCIe payloads 519 (or some other appropriate interface) where they are processed at the IO PAL layer 521 in accordance with the well-defined IO PAL requirements of the WiGig standard, and then sent to the MAC/PHY layer 522 for processing and transmission 523. At the WGA IO PAL device 530 at the receiving/sink station, the received message 523 is processed by the MAC/PHY layer 531 to generate control and data packets that are processed as IO packets by the WGA IO PAL device 532 in accordance with the well-defined requirements of the WiGig standard. After IO packet processing, the IO data is then sent to an downstream device, such as a TV SOC device 540, where it is processed stored in the frame buffer memory 545.

Up to this point, the source station 501 and WGA IO devices 520, 530 operate as standard IO PAL devices, and there is no special processing for AV PAL packets, other than to convey the AV PAL blocks (e.g., AV PAL B1, AV PAL B2, . . . AV PAL Bn) at specified addresses in the IO PAL payload of the transmitted message 523. However, the downstream device 540 includes an AV packet selection unit 541 which is configured to retrieve AV PAL blocks from the PCIe data 533 at the specified addresses for storage in the external frame buffer 545. The selected AV packets from the buffer 545 are then processed by the video decoder unit 543 and decryption unit 544 of the AV PAL device 542. In these embodiments, the AV selection unit 541 may be implemented in software using the processor(s) of the TV SOC device 540, and video decoding will be handled by the video decoder inside the TV SOC. In this way, the AV PAL layers are virtualized at the downstream device 540 so that they run outside of the WGA IO PAL devices 520, 530. By using the AV packet selection unit 541 to retrieve AV packets from the PCIe data 533 for the display device 540, the receiver/sink station is able to receive AV packets 523 from the source station 501 using only WGA IO PAL devices 520, 530 without requiring a dedicated WGA AV PAL device.

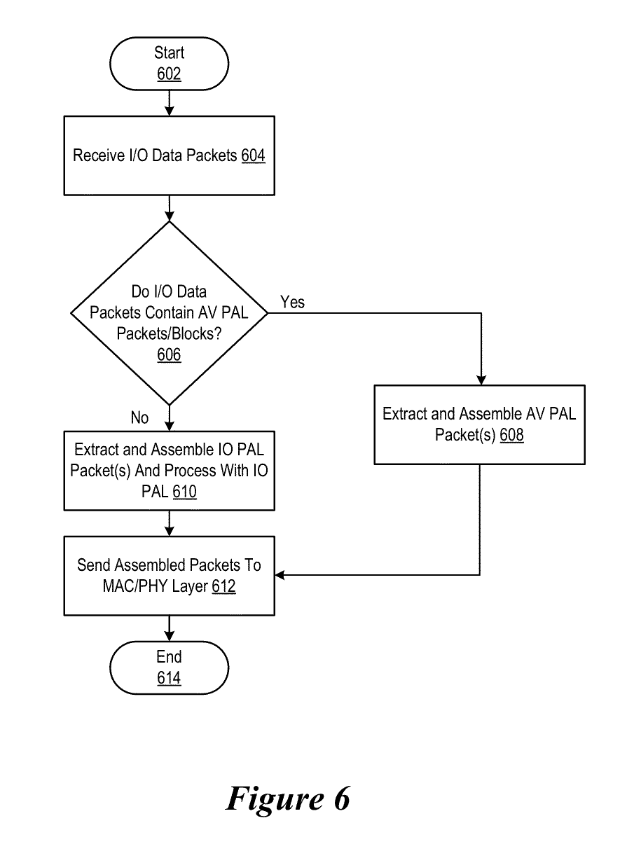

Turning now to FIG. 6, an exemplary method is illustrated for translating between IO PAL packets into AV PAL packets. After the method begins at step 602, data packets are received at step 604 which are formatted in accordance with a first format (e.g., I/O data, such as PCIe or USB data), at step 604. For example, the WGA IO PAL device at the source station may receive an outgoing packet from the CPU/CPU sub-system which is intended for transmission. If the data packets include AV PAL packets or blocks (affirmative outcome to decision 606), then the AV PAL packets are extracted from the data packets and assembled at step 608 and sent directly to the MAC/PHY layer 612 for additional transmission processing. However, if it is determined that there are no AV PAL packets contained in the received data packets (negative outcome to decision 606), then the received data packets are processed as IO PAL packets at step 610 before being sent to the MAC/PHY layer at step 612 for additional transmission processing. While a variety of techniques may be used at step 606 to determine if the data packets include AV PAL packets, in selected embodiments, the decision may be based a specified destination address in the data packets (e.g., a PCIe address in the case of PCIe PAL) or a specified address (or range of address) that the data come from. In the example case where an outgoing packet is determined at step 606 to be an IO PAL type packet that is being sent to an AV PAL type destination station, then the control and/or data packets of the outgoing IO PAL packet are translated by the PAL translation layer into AV PAL type packets (step 608) before being processed at step 612. At step 614, the process ends.

By now it will be appreciated that there is provided a method and apparatus for transmitting wireless signals. In the disclosed system, a processor and a first protocol adaption layer (PAL) device are provided. The processor generates data packets at a first data interface which are formatted in accordance with a first WiGig protocol adaptation layer. The first PAL device is adapted to translate selected packets at the first PAL device into translated packets formatted in accordance with a second different WiGig protocol adaptation layer and to convey the translated packets directly to a media access control (MAC) layer without further processing under the first protocol adaptation layer. To this end, the first PAL device receives packets which are formatted in accordance with a first protocol adaptation layer (e.g., WBE). The packets are translated at the first PAL device into translated packets which are formatted in accordance with a second different protocol adaptation layer (e.g. AV PAL or WOE). In selected embodiments, the packet translation process includes processing at the IO/AV translator to determine that the packets include AV PAL packets and to extract the AV PAL packets from the received packets for presentation to the MAC layer at the first protocol adaption layer device. In this way, the first PAL device also conveys the translated packets directly to a media access control (MAC) layer and a physical (PHY) layer for transmission without further processing the translated packets under the first protocol adaptation layer. In embodiments where the first PAL device is an IO PAL device at a source station, the translated packets may be transmitted to an audio/video protocol adaptation layer (AV PAL) device at a sink station. In embodiments where the first PAL device is an AV PAL device at a sink station, the received packets may be AV control packets formatted in accordance with the audio/visual adaptation layer protocol. In such embodiments, the received packets are translated into control packets formatted in accordance with an input/output protocol adaptation layer and then processed with a MAC layer at the audio/visual protocol adaptation layer device for transmission to an input/output protocol adaptation layer device at a source station. As described herein, the steps of receiving, translating and conveying are performed entirely at a sink station, or alternatively entirely at a source station

In other embodiments, there is disclosed a computer program embodied on a computer-readable medium that stores instructions operable to control operation of one or more processors or circuits to receive packets at a first protocol adaption layer device which are formatted in accordance with a first protocol adaptation layer, translate the packets at the first protocol adaption layer device into translated packets which are formatted in accordance with a second different protocol adaptation layer, and convey the translated packets directly to a media access control (MAC) layer and a physical (PHY) layer for transmission without further processing the translated packets under the first protocol adaptation layer. As will be appreciated, any software-implemented aspects may be encoded on some form of program storage medium or implemented over some type of tangible transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art.

As described herein, selected aspects of the invention as disclosed above may be implemented in hardware or software. Thus, some portions of the detailed descriptions herein are consequently presented in terms of a hardware-implemented process and some portions of the detailed descriptions herein are consequently presented in terms of a software-implemented process involving symbolic representations of operations on data bits within a memory of a computing system or computing device. Generally speaking, computer hardware is the physical part of a computer, including its digital circuitry, as distinguished from the computer software that executes within the hardware. The hardware of a computer is infrequently changed, in comparison with software and hardware data, which are “soft” in the sense that they are readily created, modified or erased on the computer. These descriptions and representations are the means used by those in the art to convey most effectively the substance of their work to others skilled in the art using both hardware and software.

The particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

What is claimed is:

1. A method for transmitting wireless signals, comprising:
receiving packets at a first protocol adaption layer device which are formatted in accordance with a first protocol adaptation layer;
translating the packets at the first protocol adaption layer device into translated packets which are formatted in accordance with a second different protocol adaptation layer; and
conveying the translated packets directly to a media access control (MAC) layer and a physical (PHY) layer for transmission without further processing the translated packets under the first protocol adaptation layer.

2. The method for transmitting wireless signals of claim 1, where the first protocol adaptation layer device comprises an input/output protocol adaptation layer device, a WiGig Serial Extension (WSE) device, or a WiGig Bus Extension (WBE) device located at a source station.

3. The method for transmitting wireless signals of claim 2, where conveying the translated packets comprises processing the translated packets with a MAC layer at the input/output protocol adaptation layer device.

4. The method for transmitting wireless signals of claim 2, where conveying the translated packets comprises transmitting the translated packets to an audio/video protocol adaptation layer device at a sink station.

5. The method for transmitting wireless signals of claim 1, where receiving packets comprises receiving control packets at an audio/visual protocol adaptation layer device at a sink station, where the control packets are formatted in accordance with the audio/visual adaptation layer protocol.

6. The method for transmitting wireless signals of claim 5, where translating the packets comprises translating the control packets into control packets which are formatted in accordance with an input/output protocol adaptation layer for transmission to an input/output protocol adaptation layer device at a source station.

7. The method for transmitting wireless signals of claim 5, where conveying the translated control packets comprises processing the translated control packets with a MAC layer at the audio/visual protocol adaptation layer device.

8. The method of claim 1, wherein the receiving, translating and conveying are performed at only one of a: sink station and a source station

9. The method for transmitting wireless signals of claim 1 where translating the packets comprises:
determining that the packets comprise audio/visual protocol adaptation layer packets;
extracting the audio/visual protocol adaptation layer packets from the packets; and
presenting the extracted audio/visual protocol adaptation layer packets to a MAC layer at the first protocol adaption layer device.

10. A wireless communication device comprising:
a processor for generating data packets at a first data interface which are formatted in accordance with a first WiGig protocol adaptation layer; and
a first protocol adaption layer device adapted to translate selected packets at the first protocol adaption layer device into translated packets formatted in accordance with a second different WiGig protocol adaptation layer and to convey the translated packets directly to a media access control (MAC) layer without further processing under the first protocol adaptation layer.

11. The wireless communication device of claim 10, where the first protocol adaptation layer device comprises an input/output protocol adaptation layer (IO PAL) device, a WiGig Serial Extension (WSE) device, or a WiGig Bus Extension (WBE) device located at a source station.

12. The wireless communication device of claim 11, where the first protocol adaption layer device conveys the translated packets by processing the translated packets with a MAC layer at the IO PAL device, WSE device or WBE device.

13. The wireless communication device of claim 11, where the first protocol adaption layer device conveys the translated packets by transmitting the translated packets to an audio/video protocol adaptation layer device at a sink station.

14. The wireless communication device of claim 10, where the first protocol adaptation layer device comprises an audio/visual protocol adaptation layer device at a sink station which receives control packets formatted in accordance with the audio/visual adaptation layer protocol.

15. The wireless communication device of claim 14, where the audio/visual protocol adaptation layer device translates the control packets into translated control packets which are formatted in accordance with an input/output protocol adaptation layer for transmission to an input/output protocol adaptation layer device at a source station.

16. The wireless communication device of claim 14, where the audio/visual protocol adaptation layer device conveys the translated control packets by processing the translated control packets with a MAC layer at the audio/visual protocol adaptation layer device.

17. The wireless communication device of claim 10 wherein the wireless communication device comprises a sink station.

18. The wireless communication device of claim 10 wherein the wireless communication device comprises a source station.

19. The wireless communication device of claim 10, where the first protocol adaption layer device is adapted to:
determine which of the data packets at a first data interface comprise audio/visual protocol adaptation layer packets;
extract the audio/visual protocol adaptation layer packets from the data packets; and
present the extracted audio/visual protocol adaptation layer packets to a MAC layer at the first protocol adaption layer device.

20. A computer program embodied on a computer-readable medium, the computer program configured to control a processor to:
receive packets at a first protocol adaption layer device which are formatted in accordance with a first protocol adaptation layer;
translate the packets at the first protocol adaption layer device into translated packets which are formatted in accordance with a second different protocol adaptation layer; and
convey the translated packets directly to a media access control (MAC) layer and a physical (PHY) layer for transmission without further processing the translated packets under the first protocol adaptation layer
